(19) United States
(12) Patent Application Publication
(10) Pub. No.: US 2002/0171251 A1
(43) Pub. Date: Nov. 21, 2002

(54) Push-push locking mechanism

(76) Inventors: Torsten Bieck, Waldachtal (DE); Gundolf Kaupp, Horb-Altheim (DE); Andreas Schneider, Freudenstadt (DE); Steffen Breunig, Pfozheim (DE)

Correspondence Address: STRIKER, STRIKER & STENBY, 103 East Neck Road, Huntington, NY, 11743, US

(21) Appl. No.: 10/128,834

(22) Filed: Apr. 23, 2002

(30) Foreign Application Priority Data
Apr. 26, 2001 (DE) 101 20 435.3

(51) Int. Cl. E05B 3/00

(52) U.S. Cl. 292/336.3

(57) ABSTRACT

An inertia locking mechanism used to hold a drawer closed by preventing self-actuated opening of the drawer (10) during an automobile accident includes a heart-shaped slide channel and a cooperating pin (44) arranged on a pivotable rectangular lever (36) that has an additional weight (48). In the event of an accident, the additional weight (48) exerts a moment upon the lever (36) that prevents release of the pin (44) by a heart-shaped pin (52) of the heart-shaped slide channel (38).

### BACKGROUND OF THE INVENTION

The present invention relates generally to a push-push locking mechanism with a slide channel and a cooperating pin, which, by over-pushing into a locking direction by means of a locked position in the slide channel, is released or unlocked.

General types of push-push locking mechanism are known, which serve to hold closed a drawers or the like, and also glove box lids in motor vehicles or other transportation means. Such devices can be provided with an opening spring element that opens the drawer or cover after unlocking or release of the push-push locking mechanism. The state of the art push-push locking mechanisms have a slide channel or slide channel way, which can be provided on the drawer or in a fixed position, and a pin that cooperates with the slide channel. Upon displacement (closing) of the drawer, the pin enters the slide channel and is moved by the slide channel into an undercut of the slide channel. The undercut of the slide channel holds the pin and thereby prevents the drawer from opening, and the push-push locking mechanism is locked and holds the drawer in the closed position. The pin is in a locked position in the slide channel.

To open the drawer, the drawer is moved a short distance beyond the locked position in the closing or locking direction. This short movement beyond the locked position in the closing or locking direction is referred to hereinafter as “over-pushing”. In the course of “over-pushing”, the slide channel moves the pin away from the undercut, thereby releasing the pin. The push-push locking mechanism is unlocked and the drawer can be opened, that is, pulled out or can also be guided out in a spring-operated manner. This type of a push-push locking mechanism also can be provided, for example, for holding closed a glove box lid.

Violent deceleration, such as the kind that occurs during a forward impact accident, can push the locked drawer beyond the locked position in the locking direction (i.e., “over-pushing”), so that the pin is released from the undercut. The drawer, then, can be unlocked by strong deceleration forces in the event of a forward impact accident and can open as soon as the deceleration ceases or acts in a different direction, or the drawer is pushed open by the opening spring element when the deceleration ceases. The pushed-out, open drawer and its projecting position create the risk of injury. In addition, objects in the drawer can be flung about the interior of the vehicle during the accident and injure the passengers. This is also true for a cover that is being held closed by a push-push locking mechanism.

One object of the present invention is to provide a push-push locking device of the type described above that is not unlocked by violent deceleration, such as the type that occurs in the event of a forward impact collision.

### SUMMARY OF THE INVENTION

The present invention, therefore, provides a push-push locking mechanism that is formed as an inertia locking mechanism, which means that the mechanism is not unlocked by violent or strong deceleration. In order to construct the mechanism as an inertia locking mechanism, the pin is disposed on a pivotably mounted lever that has an eccentric mass. The eccentric mass can be determined by the shape of the lever, that is, through the distribution of material and mass of the lever relative to its pivoting axis. The eccentric mass of the lever is disposed so that violent deceleration, such as the type that occurs in a forward impact accident, exerts a moment on the lever that presses the pin into the slide channel to the side at which the pin enters the slide channel when the push-push locking mechanism is being locked, that is, when the drawer is being closed. When the deceleration ceases and the drawer is acted upon in the opening direction by the opening spring element, for example, the slide channel moves the pin to engage behind the undercut of the slide channel, that is, in the locked position, as when the drawer is being closed. As a result, the push-push locking mechanism and the drawer remain locked.

The effectiveness of the inertia locking mechanism is dependent on the direction of the deceleration and the moment exerted on the lever by the deceleration. The lever comprising the eccentric mass is formed and disposed in such a way that it effects the described inertia locking when the deceleration acts on the drawer in the direction of closure, that is, in the direction of “over-pushing”. That is the direction of deceleration in the case of a drawer built into a dashboard, for example, in the event of a forward impact accident. If, one the other hand, the motor vehicle is struck from behind by a vehicle, the deceleration that occurs is in precisely the opposite direction, and the inertia locking is ineffective. In that case, the deceleration does not act on the drawer in the sense of “over-pushing”, but acts in the opposite direction. Such deceleration does not unlock the push-push locking mechanism, which is why it is not necessary to the inertia locking to be effective in that case. Lateral impact also does not cause unlocking of the push-push locking mechanism, which means that the inertia locking mechanism of the present invention, which is effective only in the case of deceleration that acts in a specific direction, is sufficient to prevent unlocking of the push-push locking mechanism as a result of violent deceleration in any direction.

The push-push locking mechanism of the present invention has the advantage that it retains a drawer, a glover compartment cover, or the like in a locked position in the event of an accident, and therefore, avoids a risk of injury caused by the projecting protruding drawer or open cover or from objects that are flung from the open drawer or glove compartment. The push-push locking mechanism of the present invention is simple in its construction. In its most simple embodiment, the mechanism has only one moveable part, specifically, the lever having the eccentric mass that comprises the pin. When the drawer or cover is made of plastic, for example, the slide channel can be molded therein, and in this case, is not a separate part and requires no additional manufacturing expense.

Various constructions of push-push locking mechanism with various shaped slide channels are known. One embodiment of the invention provides a so-called heart-shaped curve as the slide channel, that is, a specialized form of a push-push locking mechanism, in which a holding pin of the slide channel (the holding pin comprising the undercut) has a heart-like appearance. The holding pin is a part of the slide channel and is to be distinguished from the previously discussed pin disposed on the pivotable lever.

The lever of the push-push locking mechanism is in the form of a rectangular lever, the pin being arranged on one arm thereof and the eccentric mass being formed by the other arm thereof. An embodiment of the present invention provides an additional weight as the eccentric mass on the lever, thereby increasing the moment exerted on the lever by the deceleration. This moment holds the push-push locking mechanism locked in the manner described above. A further advantage of this embodiment of the present invention is that the push-push locking mechanism can be better matched to the deceleration that causes the inertia locking.

### BRIEF DESCRIPTION OF THE DRAWINGS

FIG. 1 shows a perspective view of the push-push locking mechanism of the present invention; and

FIG. 2 shows a step-by-step progression of the locking and unlocking procedure of the push-push locking mechanism of FIG. 1.

### DETAILED DESCRIPTION OF THE PREFERRED EMBODIMENTS

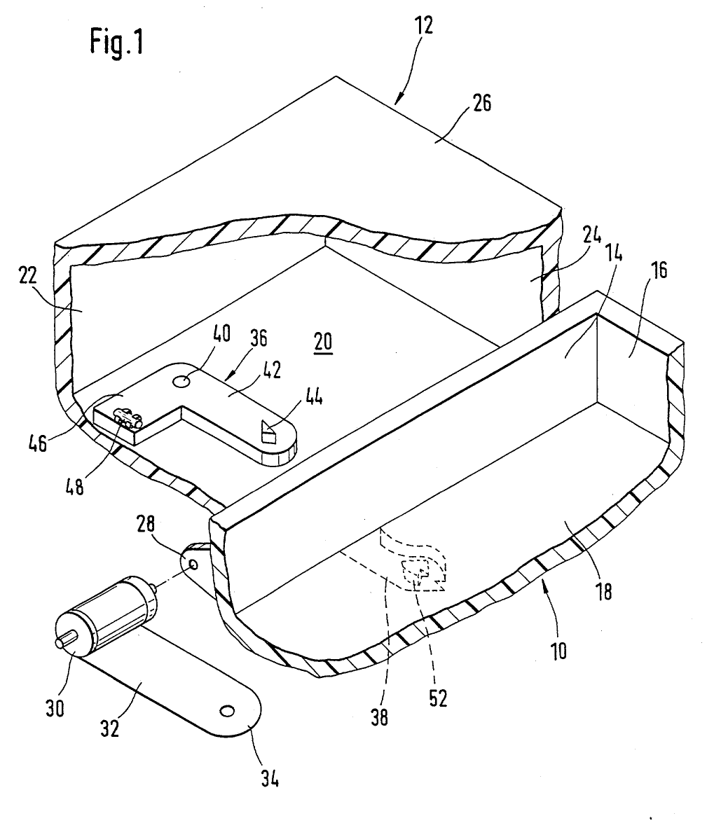

The embodiment of the push-push locking mechanism of the present invention is shown in FIG. 1 as provided on a drawer 10, which is displaceably guided into a box-shaped housing 12 that is open to the front side. FIG. 1 shows only parts of each of the drawer 10 and the housing 12. Of the drawer 10, parts of a rear wall 14, a right side wall 16, and a base 18 are visible. Of the housing 12, parts of a base 20, a rear wall 22, a right side wall 24, and a ceiling 26 are visible. The housing 12 can be arranged, for example, in a dashboard (not shown) of a vehicle, where the drawer 10 is used to store objects.

Two flanges or lugs 28 project from an outside of the rear wall 14 of the drawer 10, only one of which is visible in FIG. 1. Mounted rotatably in the lugs 28 is a coil 30 of a scroll spring 32. The scroll spring 32 is a metal-strip spring, which winds up automatically by virtue of its resiliency. The scroll spring 32 is thus a tension spring. A free end 34 of the scroll spring 32 that can be unwound is fastened to a front region of the base 20 of the housing 12 near the opening of the housing 12. As a result of its tensile force, the scroll spring 32 moves the drawer 10 out of the housing 12. The scroll spring 32 forms an opening spring element, which opens the drawer 10.

In order to hold the drawer 10 in a closed position in the housing 12 against the force of the scroll spring 32, a push-push locking mechanism of the present invention is provided, which comprises a rectangular lever 36 and a slide channel (or slide channel way) 38. The rectangular lever 36 is arranged near the rear wall 22 of the housing 12 on the base 20 of the housing 12. The base 20 has an upwardly projecting bearing pin 40 on which the rectangular lever 36 is pivotably mounted. An arm 42 of the lever 36 points forward in the direction of an opening of the housing 12. On an end of that arm 42, facing the drawer 10, an upwardly projecting pin 44 is disposed that is triangular in plan view. The pin 44 cooperates with the slide channel 38 in the manner to be explained below. For the purpose of clarity, the pin 44 will be referred to hereinafter as the triangular pin 44 because of its shape.

Another arm 46 of the rectangular lever 36 projects to the side and carries a cylindrical pin 48 as addition weight, which is clipped in position.

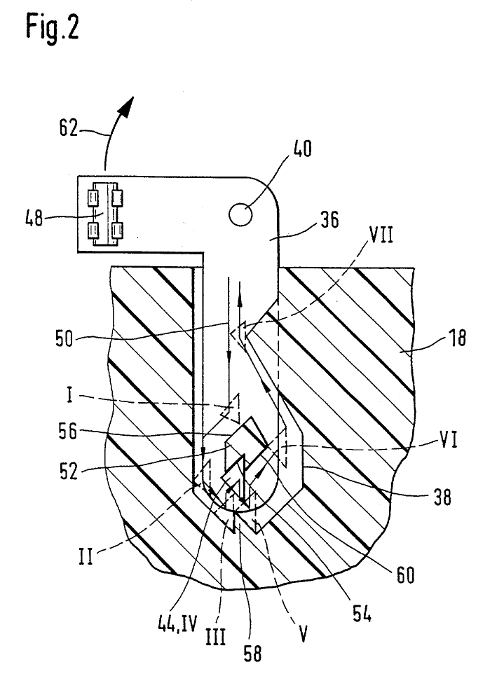

The slide channel 38, which is shown by broken lines in FIG. 1, is provided on an underside of the base 18 of the drawer 10. The slide channel 38 is a groove-like recess in the base 18 and is open to the back side of the drawer 10, thereby allowing entry of the triangular pin 44 of the rectangular lever 36 as the drawer 10 is being closed and pushed into the housing 12. The shape of the slide channel is more clearly visible in FIG. 2, which is a plan view from above onto a portion of the base 18 of the drawer 10 in the region of the slide channel 38 and the rectangular lever 36 with the triangular pin 44. In order to enable the slide channel 38 to be seen, the base 18 is shown cut in a plane parallel to the base 18, the plane cutting through the slide channel 38. FIG. 2 shows the locked position of the push-push locking mechanism. In addition, further positions of the triangular pin 44 during locking and unlocking are shown. The path of the triangular pin 44 relative to the slide channel 38 during locking and unlocking is indicated by an arrowed line 50.

The slide channel 38 of the push-push locking mechanism is formed as a so-called heart-shaped curve, and the push-push locking mechanism, therefore, also can be called a heart-shaped curve locking mechanism. In the center of the slide channel 38, the slide channel has a pin 52, which comprises a V-shaped notch 54. The V-shaped notch 54 is remote from an open side of the slide channel 38 on the rear side of the drawer 10. The V-shaped notch 54 provides the pin 52 with a heart-like shape, thus giving the slide channel 38 its name, a heart-shaped curve. The V-shaped notch 54 forms an undercut of the slide channel 38, in which the triangular pin 44 rests in the locked position and, as a result, holds the drawer 10 in the closed position. To differentiate the pin 52 from the triangular pin 44 arranged on the pivotable rectangular lever 36, the pin 52 arranged in the slide channel 38 and comprising the V-shaped notch 54 will be referred to as the heart-shaped pin 52 because of its shape. The heart-shaped pin 52 is a part of the slide channel 38. The slide channel 38 is formed around the heart-shaped pin 52 such that it guides the triangular pin 44 around the heart-shaped pin 52 along the arrowed line 50 during locking and unlocking, in the manner to be described in greater detail below.

The push-push locking mechanism functions in the following manner: to close the drawer, the drawer 10 is pushed into the housing 12 against the force of the scroll spring 32. In the process, the triangular pin 44 enters the slide channel 38 through the open side of the slide channel 38 on the rear side of the drawer 10. The heart-shaped pin 52 of the slide channel 38 comprises an oblique surface 56, which moves the triangular pin 44 arranged on the pivotable rectangular lever 36 sideways in the slide channel 38. On pushing the drawer 10 further into the housing 12, the slide channel 28 moves the triangular pin 44 around the heart-shaped pin 52 to the front end of the slide channel 38. On insertion of the drawer 10 into the housing 12, the triangular pin 44 travels the path shown in FIG. 2 by the arrowed line 50, relative to the slide channel 38, via positions I and II and as far as position III at the front end of the slide channel 38. When the drawer 10 is released, the scroll spring 32 pushes the drawer 10 a short distance out of the housing 12, causing the triangular pin 44 to engage the V-shaped noted 54 of the heart-shaped pin 52 of the slide channel 38. This is the locked position, which is indicated in FIG. 2 by the reference numeral IV. The V-shaped notch 54 forms an undercut of the slide channel 38, behind which the triangular pin 44 of the rectangular lever 36 engages in the locked position, thereby holding the drawer 10 in the closed position in the housing against the force of the scroll spring 32.

To unlock the drawer 10, the drawer is pushed a short distance into the housing 12 against the force of the scroll spring 32. This short action of pushing the drawer 10 inwards to unlock it, as previously noted, is referred to herein as “over-pushing”. In the course of over-pushing, the triangular pin 44 moves back to the front end of the slide channel 38 and is there pressed sideways into position V by a triangular point 58 of the slide channel 38. The triangular point 58 presses the triangular pin 44 to the side of the slide channel 38, a position in which the triangular pin was not disposed when the drawer 10 was being closed. When the drawer 10 is released, the scroll spring 32 pushes the drawer 10 out of the housing 12. Owing to the sideways movement of the triangular pin 44 by the point 58, the triangular pin 44 is displaced to the side of the V-shaped notch 54 of the heart-shaped pin 52, and the triangular pin 44 strikes a further oblique surface 60 of the heart-shaped pin 52, the oblique surface pressing the triangular pin 44 further to the side, thereby releasing the triangular pin 44. The push-push locking mechanism is unlocked and the drawer 10 opens, actuated by the spring.

On deceleration of a vehicle with the housing 12 and drawer 10 built into its dashboard, a moment acts upon the rectangular lever 36 in the direction of the arrow 62 as a result of inertia. This moment presses the triangular pin 44 to the side of the slide channel 38 where the pin is guided around the heart-shaped pin 52 during locking. If the deceleration of the vehicle is so high that is pushes the drawer 10 into the housing 12 against the force of the scroll spring 32 in the sense of “over-pushing”, for example in the event of a forward impact accident, the moment 62 acting on the rectangular lever 36 does not cause the triangular pin 44 to move to position V, as during unlocking. Rather, the moment 62 moves the triangular pin 44 to position III, that is, the side through which the triangular pin 44 enters the slide channel 38 when the drawer 10 is being closed. This has the result that, as deceleration ceases, the triangular pin 44 engages the V-shaped, undercut-forming notch 54 of the heart-shaped pin 52 of the slide channel 38 again as the drawer 10 is being pushed out of the housing 12 by the scroll spring 32. That is, the triangular pin 44 moves into the locked position (position IV). As a result, the push-push locking mechanism remains locked even in the event of violent deceleration, for example, as a result of an accident. The push-push locking mechanism of the present invention is in the form of an inertia locking mechanism that prevents self-actuated unlocking and opening of the drawer 10 in the event of an accident.

While the invention has been illustrated and described herein as an inertia push-push locking mechanism, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Inertia push-push locking mechanism, comprising a slide channel (38) and a pin (44) cooperating with the slide channel (38), wherein said pin (44) is released from the slide channel (38) by over-pushing the pin (44) in a locking direction beyond a locked position in the slide channel (38), wherein the pin (44) is arranged on a pivotably mounted lever (36) having an eccentric mass (46, 48), wherein said eccentric mass exerts a moment (62) upon the lever (36) in the event of violent deceleration acting upon the push-push locking mechanism in the locking direction, said moment pressing the pin (44) in the slide channel (38) to a side of the slide channel (38), wherein said pin (44) also moves to said side of the slide channel (38) during locking of the push-push mechanism.

2. Inertia push-push locking mechanism according to claim 1, wherein the slide channel (38, 52) is a heart-shaped curve.

3. Inertia push-push locking mechanism according to claim 1, wherein the lever (36) is a rectangular lever.

4. Inertia push-push locking mechanism according to claim 1, wherein the lever (36) includes an eccentrically arranged additional weight (48).
